(19) United States
(12) Patent Application Publication
(10) Pub. No.: US 2008/0268217 A1
(43) Pub. Date: Oct. 30, 2008

(54) CLOTH HAVING PARTIALLY DIFFERENT CLOTH-STRETCHABILITY AND METHOD OF MANUFACTURING THEREOF

(75) Inventors: Shouji Kanatani, Osaka-shi (JP); Atsushi Itsumi, Osaka-shi (JP); Kazuo Harada, Osaka-shi (JP); Kenichiro Takasu, Aichi-ken (JP); Kenji Uehara, Osaka-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignees: Mitsubishi Rayon Co., Ltd., Tokyo (JP); Mitsubishi Rayon Textile Co., Ltd., Osaka-shi (JP); Violetta Co., Ltd., Osaka-shi (JP); SUZUTORA CO., Ltd., Aichi-ken (JP)

(21) Appl. No.: 12/147,092

(22) Filed: Jun. 26, 2008

Related U.S. Application Data
(63) Continuation of application No. PCT/JP2006/325938, filed on Dec. 26, 2006.

(30) Foreign Application Priority Data
Dec. 26, 2005 (JP) 2005-372767
Sep. 8, 2006 (JP) 2006-243664

(51) Int. Cl. B32B 7/02; B05D 5/00

(52) U.S. Cl. 428/212; 427/288

(57) ABSTRACT

A cloth having partially different cloth-stretchability comprises a portion having relatively high cloth-stretchability and a portion having relatively low cloth-stretchability, in which the portion having a relatively high cloth-stretchability is composed of a fiber having fiber-stretchability and a fiber having non-fiber-stretchability and has a higher extension percentage than that of the portion having a relatively low cloth-stretchability. A method of manufacturing thereof comprises printing a part to be dissolved and removed of a cloth-stretchable base cloth with a dissolving paste including a dissolving accelerator to make a printed part; removing a part of or all dissolvable fiber A of the printed part; and fulfilling conditions (1) to (4):
(1) the cloth-stretchable base cloth comprises the dissolvable fiber A, a non-dissolvable fiber B, and a non-dissolvable fiber C,
(2) at least a part of the dissolvable fiber A is composed of a polymer to be dissolved by the dissolving agent,
(3) the non-dissolvable fiber B is undissolved in the dissolving agent and has fiber-stretchability,
(4) the non-dissolvable fiber C is undissolved in the dissolving agent and has non-fiber-stretchability.

### TECHNICAL FIELD

The present invention relates to a cloth having partially different cloth-stretchability and a method of manufacturing thereof, and particularly relates to a method of manufacturing a cloth having partially different cloth-stretchability by after-treatment.

The present application claims priority on Japanese Patent Application No. 2005-372767 filed on Dec. 26, 2005, and Japanese Patent Application No. 2006-243664 filed on Sep. 8, 2006, the contents of which are incorporated herein by reference.

### BACKGROUND ART

In recent years, portions with partially cloth-stretchability have been formed of other materials or stitches on a cloth for woven or knitted fabrics in order to provide a figure control or muscle support function by imparting partially different compression to clothes. Patent document 1 proposes a method of sewing a girdle or the like after attaching relatively wide tape-shaped cloths having elasticity on the back side of the girdle or the like, and a method of partially coating a resin having elasticity.

However, when the girdle or the like after attaching the cloths was sewed, the thickness of attached portions increased and differences in level occurred at the boundary between the attached portions and non-attached portions. Since the difference in level at the boundary appeared on the surface of outer wear when a person wears the outer wear, the person would not have been satisfied with the feeling when wearing the outer wear. Furthermore, a fabric (formed of the cloth) had a thickness which gave a sweaty feeling to the person. When the girdle or the like were coated by a resin agent, feeling to skin of the coated girdle or the like was inferior to that of the non-coated one and permeability was remarkably decreased and the sweaty feeling became very high because openings in the woven and knitted fabric were clogged.

Patent document 2 proposes that knitted fabrics are partially imparted with the clothing pressure by partially changing stitches or changing the number or thickness of an inserted elastic yarn using a knitting machine equipped with a Jacquard mechanism. However, a specific knitting machine equipped with a Jacquard mechanism had to be adopted in this method, and various fabrics having different stitch patterns had to be manufactured in response to a product type or size, and flexibility during manufacturing was not satisfactory. In this method, since stitches were partially changed, the fabric tended to be relatively thick.

Patent document 3 proposes that a method of carrying out a process of dissolving and removing a cloth including modified polyester fiber, nylon fiber And elastic fiber (dissolving a part of fiber of the cloth by a dissolving agent). However, patent document 3 does not propose a method of increasing cloth-stretchability in parts having dissolved and removed portions or a method of controlling cloth-stretchability with fibers composing the cloth. These fibers are merely used for improving the design or pattern.

Patent document 1: Japanese Patent Application Laid-Open No. 2001-64801
Patent document 2: Japanese Patent Application Laid-Open No. 2000-303209
Patent document 3: Japanese Patent Application Laid-Open No. 2000-282377

### DISCLOSURE OF INVENTION

### Problems to be Solved by the Invention

A subject of the present invention is to solve the above problems of current techniques, to provide a cloth having partially different cloth-stretchability by after-treatment such as a process of dissolution and removal (opal finish) with superior production efficiency, and to provide a cloth having partially different cloth-stretchability which feels thinner and less sweaty while preventing a decrease in the strength of the cloth.

### Means for Solving the Problem

A cloth having partially different cloth-stretchability according to the present invention is characterized by comprising a portion having relatively high cloth-stretchablity and a portion having relatively low cloth-stretchablity in which the portion having relatively high cloth-stretchability is composed of a fiber having fiber-stretchability and a fiber having non-fiber-stretchablity and has higher extension percentage than that of the portion having relatively low cloth-stretchability.

A method of manufacturing a cloth having partially different cloth-stretchability is characterized by printing a part to be dissolved of a cloth-stretchable base cloth with a dissolving paste including a dissolving accelerator to make a printed part, removing a part of or all of dissolvable fiber A of the printed part, and fulfilling the following conditions (1) to (4):

(1) the stretchable base cloth comprises the dissolvable fiber A, non-dissolvable fiber B, and non-dissolvable fiber C,
(2) at least a part of the dissolvable fiber A is composed of a polymer dissolved by the dissolving agent,
(3) the non-dissolvable fiber B is undissolved in the dissolving agent and has fiber-stretchability,
(4) the non-dissolvable fiber C is undissolved in the dissolving agent and has non-fiber-stretchability.

A method of manufacturing a cloth having partially different cloth-stretchability according to the present invention is characterized by printing a part to be dissolved of a stretchable base cloth with a dissolving paste including a dissolving accelerator to make a printed part, removing a part of dissolvable fiber A of the printed part, and fulfilling the following conditions (5) to (7):

(5) the cloth-stretchable base cloth comprises the dissolvable fiber A and non-dissolvable fiber B,
(6) the dissolvable fiber A is composed of a polyester polymer modified by a compound including an alkali metal sulfonic acid group and a non-dissolvable polymer which is undissolved in the dissolving agent,
(7) the non-dissolvable fiber B is undissolved in the dissolving agent and has fiber-stretchability.

### EFFECT OF THE INVENTION

According to the present invention, a cloth having partially different cloth-stretchability with low decrease of the strength of the cloth is obtained since a part having partially higher stretchability with a desired shape is formed at a desired part of the cloth by applying opal finish. Furthermore, cloths having stretchable parts having various shapes with different stretchability are obtained if a mold to be used is only changed when the dissolving paste including the dissolving accelerator is printed during the process of dissolution and removal. When clothes are made of the obtained cloth and a person puts on the clothes, the person does not feel sweaty or that the material is thick and is provided with partial different compression, thereby a cloth having partially different cloth-stretchability is obtained in the present invention.

### BEST MODES FOR CARRYING OUT THE INVENTION

A base cloth of a cloth to be treated in the present invention is, for example, composed of a dissolvable fiber A in which at least a part thereof is composed of a polymer to be dissolved by a dissolving agent, a non-dissolvable fiber B which is undissolved in the dissolving agent and has fiber-stretchability, and a non-dissolvable fiber C which is undissolved in the dissolving agent and has non-fiber-stretchability. The stretchability of the base cloth appears by using the non-dissolvable fiber B having fiber-stretchability.

In the present invention, the “cloth-stretchability” means stretchability in a cloth and the “fiber-stretchability” means stretchability in a fiber.

In the dissolvable fiber A composing the base cloth, at least a part of the fiber A is composed of a polymer to be dissolved by a dissolving agent used in a process of dissolution and removal. In dependence on the polymer to be dissolved by the dissolving agent and the dissolving agent, the dissolvable fiber A may be a fiber such as a conjugated fiber Comprising a non-dissolvable polymer.

The kind of dissolvable fiber A is different in dependence on the dissolving agent to be used. The dissolvable fiber A can be suitably selected in response to the dissolving agent to be used, or the dissolving agent can be selected in response to the kind of dissolvable fiber A.

The above dissolving agent has to dissolve a fiber to be removed and has to be able to be used in treatment safety and easily. When aluminum sulfate or acid sodium sulfate is used as a dissolving agent, cellulose fiber such as rayon, Bemberg®, lyocell, and cotton and polyamide fiber such as 6,6-nylon can be used. Sodium hydroxide which is in the condition of an alkali solution in a hot water condition can be used as a dissolving agent, and, in this case, unmodified polyester fiber Can be used as the dissolvable fiber A.

Examples of dissolving accelerators which are used in a printing process of a dissolving paste including the dissolving accelerator, include amines such as diethanol amine and triethanol amine; polyalcohol-ethylene oxide adducts in which two mol or more ethylene oxide are added to polyalcohol; and a mixture of polyalcohol-ethylene oxide adducts and quaternary ammonium salt. When these dissolving accelerators are used and sodium hydroxide which is in the condition of an alkali solution in a hot water condition is used as a dissolving agent, polyester fiber modified with a compound including an alkali metal sulfonic group, in which the modified polyester fiber has higher solubility than that of unmodified polyester fiber, is preferably used. Since the modified polyester fiber modified with the compound including alkali metal sulfonic group is used, the difference in the degree of dissolution and removal between a printed part and a non-printed part increases.

When both rayon and polyester fiber which is modified with a compound including an alkali metal sulfonic group are used as the dissolvable fiber A, in response to the state of the dissolvable fiber A, a process of printing the dissolving agent partially and a process of dissolving and removing the dissolvable fiber A by the dissolving agent can be repeated if the dissolving agent is changed.

The polyester fiber modified with the compound including an alkali metal sulfonic group may be a fiber Consisting of only a polyester polymer modified with the compound including an alkali metal sulfonic group, or a conjugated fiber containing the conjugated structure of a polyester polymer modified with the compound including an alkali metal sulfonic group and a non-dissolvable polymer which is undissolved in the dissolving agent. In the conjugated structure, the polyester polymer modified with the compound including an alkali metal sulfonic group is preferably exposed on the surface of the conjugated fiber. In the conjugated fiber, the strength of the cloth is maintained since the non-dissolvable polymer which is undissolved in the dissolving agent remains as a fine fiber after the process of dissolution and removal.

Examples of the conjugated structures when the dissolvable fiber A is conjugated fiber include a side-by-side type, core-sheath type, or sea-island type (island-in-the-sea type) structure in which 30% by mass or more, preferably 50% by mass or more of a polymer to be dissolved by the dissolving agent, preferably a polyester polymer modified with a compound including an alkali metal sulfonic group. In view of the form and the strength of the thin fiber of the non-dissolvable polymer which remains after dissolution and removal, the core-sheath type structure is preferably used.

A preferable example of the polymer dissolved by the dissolving agent, in which the polymer composes the dissolvable fiber A, includes the polyester polymer modified with the compound including an alkali metal sulfonic group, and specifically, polyethylene terephthalate obtained by copolymerizing 0.5 to 5.0% by mol 5-sodium sulfo isophthalate and 2.0 to 13.0% by mol dicarboxylate of adipic acid or the like as the compound including an alkali metal sulfonic group.

When the dissolvable fiber A is the conjugated fiber, examples of a non-dissolvable polymer including the conjugated component, which may be undissolved in dependence on a dissolving agent to be used, include polyester polymer such as polyethylene terephthalate copolymerized with less than 0.5% by mol compound including or not including an alkali metal sulfonic group; polyester polymer such as polyethylene terephthalate copolymerized with 1 to 15% by mol compound, which is not a compound including an alkali metal sulfonic group, such as isophtharic acid, adipic acid, cyclohexadicarboxylic acid, trimellitic acid, polyalkylene glycol, tetraethylene glycol, and bisphenol A; and polyamide polymer such as 6,6-nylon polymer and 6-nylon polymer.

The non-dissolvable fiber B composing the base cloth and having fiber-stretchability controls the cloth-stretchability of the cloth. The non-dissolvable fiber B is not dissolved in the dissolving agent to be used and preferably having a fiber-stretchability of 30% or more of the stretch and elongation ratio. When the dissolving agent to be used is an alkali solution in a hot water condition of aluminum sulfate; acid sodium sulfate; or sodium hydroxide, elastic fiber such as a polyurethane fiber called spandex is preferably used as the non-dissolvable fiber B having fiber-stretchability. Otherwise, as the non-dissolvable fiber B having fiber-stretchability, a conjugated fiber including a side-by-side or eccentric core-sheath type conjugated structure and having a high crimp formation property is used. The conjugated structure is formed by combining the same kind or different kinds of polymers such as polyester, polyamide, or polyacrylonitrile which include different properties of elastic recovery, heat shrinkage, and plastic deformation.

The non-dissolvable fiber C composing the base cloth is a fiber reinforcing the cloth, especially, the part having dissolved and removed portions, and is not dissolved in the dissolving agent to be used. The non-dissolvable fiber C is preferably a non-fiber-stretchable fiber having less than 30% of the stretch and elongation ratio. When the dissolving agent to be used is aluminum sulfate or acid sodium sulfate, cellulose fiber such as rayon, Bemberg®, lyocell, and cotton or polyamide fiber such as 6,6-nylon is used. When the dissolving agent is sodium hydroxide which is in the condition of an alkali solution in a hot water condition, unmodified polyester fiber such as polyethylene terephthalate fiber or polyester fiber modified with a compound other than the compound including an alkali metal sulfonic group is used. When the dissolvable fiber A is a conjugated fiber having a core-sheath structure formed by combining a polymer which is dissolved in the dissolving agent such as polyester polymer modified with a compound including an alkali metal sulfonic group and a non-dissolvable polymer which is not dissolved in the dissolving agent, the non-dissolvable fiber C can be replaced by a fiber of the non-dissolvable polymer which remains after dissolving process.

The base cloth is woven or knitted fabric consisting of the dissolvable fiber A and the non-dissolvable fiber B having fiber-stretchability, and the non-dissolvable fiber C having non-fiber-stretchability. In order to partially impart remarkable different cloth-stretchability, it is desired that the difference of cloth-stretchability of each part is increased. For increasing the difference of cloth-stretchability, it is preferred that the base cloth is a knitted fabric because the base cloth which is a cloth to be processed tends structurally to exhibit cloth-stretchability. Examples of knitted fabric include warp knitting such as raschel knits or tricot knits; weft knitting such as circular knitting or flat knitting; knitting including patterns according to a knitting machine equipped with a Jacquard mechanism; multilayer knitting; and lace base fabric.

The fiber-form of the dissolvable fiber A, the non-dissolvable fiber B having fiber-stretchability, and the non-dissolvable fiber C having non-fiber-stretchability is preferably filament yarn in view of exerting each function. Fineness and component ratio of each fiber are optionally selected and are not especially limited. In preferably used knitted fabric, each fiber is used as yarn composing each stitch by knit stitches. In order to dominatingly control the cloth-stretchability of knitted fabric by the non-dissolvable fiber B having fiber-stretchability, the non-dissolvable fiber B having fiber-stretchability is preferably used as an insertion yarn, and the dissolvable fiber A and the non-dissolvable fiber C having non-fiber-stretchability are preferably used as a composition yarn.

As the process of dissolution and removal for treating the base cloth, a well-known process which is generally used including a process of partially printing a dissolving paste including a dissolving accelerator and a process of dissolution and removal a part of or the whole of the dissolvable fiber A provided at the printed part with the dissolving agent. In the process of printing the dissolving paste including the dissolving accelerator, the dissolving paste made by including the dissolving accelerator in a fabric size is printed. The dissolving accelerators are exemplified above. The fabric size used for the dissolving paste is not especially limited and well-known fabric sizes are used. Examples of the fabric sizes include wheat starch, tragacanth gum, locust bean gum, guar gum, polyvinyl alcohol, sodium polyacrylate, and the like. These fabric sizes may be used alone or in combination of two or more kinds.

The dissolving paste is preferably printed with a mold. The dissolving paste is printed to the portion of the base cloth to which high cloth-stretchability is provided by suitably changing the mold in accordance with the size of, pattern of, and number of the part to be dissolved and removed, and the area ratio of the part having dissolved and removed portions to the part having no dissolved and removed portion. Desirable patterns such as large patterns occupying a relatively wide area or small patterns like dots can be obtained by changing the mold. The process of printing the dissolving agent may include a drying or heating process after printing the dissolving paste. In the process of removing the dissolvable fiber A, a part of or the whole of the dissolvable fiber A is removed by entirely dissolving parts (which are dissolvable with the dissolving agent) of the polymer composing the dissolvable fiber A using the dissolving agent. In the process of removing the dissolvable fiber A, the dissolvable fiber A is removed by the dissolving agent which is in an active state, and further the process may include steaming, thermal treatment, water washing, drying, and the like. A pretreatment of the thermal dissolving and removing treatment may be carried out. The pretreatment can accelerate removal of the dissolvable fiber A using the other dissolving accelerator.

In the part having dissolved and removed portions of the cloth after carrying out the treatment of dissolving and removing, since the whole of the dissolvable fiber A composing the base cloth is removed or the dissolvable fiber A exists as a thin fiber when a part of the dissolvable fiber A is not removed, the textile density is decreased and the area of each opening between fibers is increased, and also the ratio between the non-dissolvable fiber B having fiber-stretchability and the non-dissolvable fiber C having non-fiber-stretchability becomes relatively high. Thereby, binding force to the non-dissolvable fiber B is degraded and the degree of freedom of movement of the non-dissolvable fiber B is increased, so that the part having dissolved and removed portions allows easier expansion and contraction. Thereby, the cloth-stretchability of the part having dissolved and removed portions is higher than that of the part having no dissolved and removed portion, so the difference between these cloth-stretchabilities is generated. The obtained cloth of the present invention includes parts having inherent cloth-stretchability of the base cloth and parts having higher cloth-stretchability than that of the base cloth. When clothes are made of the obtained cloth and a person puts on the clothes, the part having dissolved and removed portions (having higher cloth-stretchability) imparts compression to be provided to the person which is lower than that of the part having no dissolved and removed portion, so that the clothes having partially different compression is obtained.

In order to generate partially different compression when the clothes are made of the cloth of the present invention, it is preferred that the different cloth-stretchability is imparted to each of the part having no dissolved and removed portion and the part having dissolved and removed portions in the warp or weft direction or both warp and weft directions of the cloth by dissolving and removing so that the extension percentage of the part having dissolved and removed portions to the part having no dissolved and removed portion is 1.1 to 5.5, and the stress ratio when extended to 30% of the part having dissolved and removed portions to the part having no dissolved and removed portion is 0.05 to 0.9.

As a specific preferable example of the cloth having partially different stretchability, the dissolvable fiber A includes a polyester fiber modified by a compound including an alkali metal sulfonic acid group, the non-dissolvable fiber B having fiber-stretchability includes polyurethane fiber And the non-dissolvable fiber C having non-fiber-stretchability includes polyamide fiber. The polyester fiber modified by a compound including an alkali metal sulfonic acid group shows dyeability to cationic dye and the polyamide fiber shows dyeability to acid dye and reactive dye. When these fibers are combined, a suitable combination of dyes enables the base cloth to be dyed multicolor when the cloth is dyed after dissolved and removed. Furthermore, a partially different stretchability, a transparent effect by the process of dissolution and removal, and a partial multicolor effect are imparted to the base cloth, so that the design of the obtained cloth is improved. The dyeing method is not especially limited and usual methods such as dip dyeing are used.

The polyester fiber modified by a compound including an alkali metal sulfonic acid group shows excellent dissolvability to the alkali solution in a hot water condition of sodium hydroxide or the like (which is a dissolving agent), so that the modified polyester polymer which is a dissolvable polymer composing fiber is completely dissolved and removed at the printed part of the dissolving paste including the dissolving accelerator. In the cloth including the polyester fiber modified with a compound including an alkali metal sulfonic acid group as a dissolvable fiber A, the modified polyester fiber is dissolved and removed at the printed part of the dissolving paste including the dissolving accelerator by the alkali solution in a hot water condition of sodium hydroxide or the like, and a weight reduction process is carried out at the unprinted part in which the weight reduction process is the same process that is applicable to a usual unmodified polyester fiber. Therefore, in the cloth including the unmodified polyester fiber as the non-dissolvable fiber C, both the removing process of the modified polyester fiber at the printed part and the weight reduction process at the unprinted part are carried out at the same time, so that various feelings can be imparted to the cloth.

In the present invention, coloring can be carried out together with dissolving and removing by adding a dye which is not influenced with the dissolving accelerator during the dissolving paste is printed in the process of dissolution and removal, and further dyeing can be carried out after the process of dissolution and removal. Furthermore, after the process of dissolution and removal is carried out and then dyeing process is carried out if necessary, partially different stretchability can be imparted into the part having no dissolved and removed portion of the cloth by conducting resin finishing to a part of the part having no dissolved and removed portion. In the resin finishing, a paste or liquid resin is applied or impregnated and then fixed to the cloth. As a resin for the resin finishing, a resin for finishing such as polyester-based urethane polymer, polyether-based polymer, polyacrylic acid-based polymer, modified amino acid-urethane polymer, or silicone rubber polymer is exemplified. The paste or liquid of the resin is applied to the cloth by a rotary screen printing machine or a gravure coating machine and then dried to fix it to the cloth. When clothes are made of the cloth, it is preferred that the resin finishing is conducted to the outer surface of a product for preventing the unfavorable touch on a skin, however, when the external appearance of the product is a very important thing, the resin finishing can be conducted to the inner surface of the product. When the resin finishing is conducted, generally an unfavorable touch and decrease of air permeability tend to be generated in the clothes. These defects can be improved by conducting the resin finishing which is not a method of coating all over the surface but is a method of coating discontinuously to provide a discontinuous aggregate of resin adhesion parts such as dots.

In the part having no dissolved and removed portion to which the resin finishing is conducted, motion of fibers is suppressed by increasing binding force to the fiber By the fixed resin, thereby, the cloth-stretchability of that part is lower than that of the part having no dissolved and removed portion to which the resin finishing is not conducted. Therefore, the cloth of the present invention obtained by conducting the resin finishing has a part having inherent cloth-stretchability of the base cloth, a part having higher cloth-stretchability than that of the base cloth, and a part having lower cloth-stretchability than that of the base cloth. When clothes are made of the obtained cloth, the part having no dissolved and removed portion to which the resin finishing is conducted having lower cloth-stretchability has higher compression to be provided to a person than that of the part having no dissolved and removed portion to which the resin finishing is not conducted, therefore, partially multistage different compression generates in the clothes.

Clothes using the cloth having partially different stretchability according to the present invention exert a figure control or muscle support function by imparting partially different compression based on the difference of cloth-stretchability. The cloth according to the present invention can be used for clothing, which needs partially cloth-stretchability, such as a girdle, a body suit, a leotard, panties, brassieres, leggings (spats), a towel for sports, socks, a lace, or a swimming wear.

### EXAMPLES

The present invention will be explained with reference to the following examples. In the present invention, evaluation of cloth-stretchability, measurement of the strength of a cloth, and the like were carried out by the following methods.

### Extension Percentage and Ratio of Extension Percentages

The extension percentage in the present invention is obtained by measuring and calculating as follows.

Samples to be measured are prepared by extracting three cut textiles (3 cm width×6 cm length) in the warp direction and in the weft direction respectively, making mesh of each cut textile uniformly in the fiber direction, and adjusting the width of each cut textile to 2.5 cm. Each sample is fixed by clamps with a clamping width of 3 cm in a constant-rate-of-extension type tensile testing machine. A load-extension curve was drawn at the strain rate 3 cm/min (100% of the clamping width) and the extension percentage E when the load was 14.7 N (1.5 kgf) is calculated using the following formula.

Extension percentage E(%)=[(L1−L0)/L0]×100

L0: Length of sample before starting tensile test (3 cm)
L1: Length of sample when load was 14.7 N (1.5 kgf) (cm)

The ratio of extension percentages was determined by determining extension percentages at a part having dissolved and removed portions and a part having no dissolved and removed portion by a process of dissolution and removal in both the warp and weft directions of a cloth, and calculating the ratio of the extension percentage at the part having dissolved and removed portions and the extension percentage at the part having no dissolved and removed portion in the same direction.

(Ratio of extension percentages)=[Extension percentage at a part having dissolved and removed portions (%)]/[Extension percentage at a part having no dissolved and removed portion (%)]

Stress when Extended to 30% Length, and Stress Ratio when Extended to 30% Length

Stress when extended to 30% length is stress (cN/gf) measured when the sample is extended to 30% of its length while measuring the above-described extension percentages and the stress is read by the load-extension curve. The stress when extended to 30% of its length indicates a resistance of the cloth, and is an index showing the tight-fitting feeling to a human body when the cloth is extended to 30% length, in which the state of the cloth being worn by a person is presumed to be extended 30% of its length (extended to 30% more than its non-extended length). If some cloths have the same extension percentages but different stresses, their compressive feelings to the human body differ therewith. When the stress is small, a person feels a small compressive feeling, and when the stress is high, a person feels large compressive feeling.

The stress ratio when extended to 30% of its length is the ratio of the stress when extended to 30% of its length of the part having dissolved and removed portions to the stress when extended to 30% of its length of the part having no dissolved and removed portion in the same direction. The stress ratio when extended to 30% length is calculated by the following formula.

(Stress ratio when extended to 30% length)=[stress when extended to 30% length of the part having dissolved and removed portions (cN/gf)]/[stress when extended to 30% length of the part having no dissolved and removed portion (cN/gf)]

As the stress ratio when extended to 30% length is decreased, the difference of cloth-stretchability between the part having dissolved and removed portions and the part having no dissolved and removed portion is increased, and then the difference of cloth-stretchability imparts different compressive feelings between the part having dissolved and removed portions and the part having no dissolved and removed portion to a person.

### Fiber-Stretch and Extension Percentage

Fiber-stretch and extension percentage of fiber is determined by measuring and calculating as follows.

The fiber which was reeled five-times by a sizing reel was doubled and hooked over a stand with a load of 1/6000 (g/D). The fiber was stood for 30 minutes, and then was soaked in boiling water for 20 minutes. Thereafter, the fiber was dried by air for 30 minutes and was loaded with 1/500 (g/D). Then, the length (a) of the fiber was measured. Next, the load of 1/500 (g/D) was removed, the load of 1/20 (g/D) was provided to the fiber And then the length (b) of the fiber was measured. The Fiber-stretch and extension percentage was calculated by the following formula.

Fiber-stretch and extension percentage (%)=[(b−a)/b]×100

### Cloth Strength

The cloth strength was obtained by bursting strength A method (Muhlen method) in accordance with JIS L1018.

As an evaluation sample, a circular part having a diameter of 4 cm consisting of only a part having no dissolved and removed portion and a circular part having 4 cm diameter consisting only of a part having dissolved and removed portions were sampled, in which each circular part included a bursting portion (3 cm diameter) of the middle position of specimen and had a diameter of 4 cm by adding a diameter of 1 cm. If the sample included both a part having dissolved and removed portions and a part having no dissolved and removed portion due to a fine pattern, the sample was measured after recording the percentage of the part having dissolved and removed portions on the circular part having a diameter of 4 cm. The cloth strength preferably has 150 kPa or more when the cloth is a thin stretchable cloth though it can differ depending on the goods being manufactured. If the cloth strength is less than 150 kPa, the cloth tends to tear when it is extremely extended, and thereby goods made of the cloth tend to become defective products.

### Example 1

A composition yarn was prepared to have a “TRISKIN” structure by using an untwisted yarn of 33 decitex (dtex)/12 filaments (f) modified polyethylene terephthalate fiber As a dissolvable fiber A obtained by copolymerizing 2.25% by mol of a compound including an alkali metal sulfonic acid group (5-sodium sulfo isophthalic acid) and 5.0% by mol of adipic acid; and 44 dtex/20 f of 6/6 nylon fiber As a non-dissolvable fiber C having non-stretchability. An insertion yarn was prepared by combining 44 dtex/1f of polyurethane fiber And 156 dtex/1f of polyurethane fiber As a non-dissolvable fiber B having stretchability. After extending the insertion yarn to be a double length, the composition yarn and the insertion yarn were knitted to prepare a Raschel knit. The Raschel knit was heated from a low temperature to 80° C. gradually and then was scoured with open width at 80° C. The scoured Raschel knit was set at a predetermined width at setting temperature of 180° C. of a temperature setter to prepare a base knit of a cloth having a course of 46/inch, a well of 49/inch, and an opening of 260 g/m².

The used modified polyethylene terephthalate fiber, which was the dissolvable fiber A, had a fiber-stretch and extension percentage of 31.2%; the 6/6 nylon fiber, which was the non-dissolvable fiber C having non-stretchability, had a fiber-stretch and extension percentage of 42%; and one polyurethane fiber had fiber-stretch and extension percentage of 500% and another polyurethane fiber had a fiber-stretch and extension percentage of 500%, which were the non-dissolvable fibers B having stretchability. The mixing ratio (weight) of these fibers in the base knit was 45% of the modified polyethylene terephthalate fiber, 40% of 6/6 nylon fiber, and 15% of polyurethane fiber.

The base knit was dissolved and removed by using a dissolving paste including a dissolving accelerator as follows and a sodium hydroxide aqueous solution in the hot water condition as a dissolving agent. The process of dissolution and removal included the first step of printing the dissolving paste on predetermined parts of the base knit, drying the printed parts, and dry-heating the printed parts for two minutes at 80° C.; and the second step of removing the dissolvable fiber A composing the printed parts by washing the printed parts with hot water, soaked the printed parts in the sodium hydroxide 10 g/l aqueous solution for 30 minutes, neutralizing with a weak acid, and washing. The dissolving paste was printed on the predetermined parts which were desired to be the most stretchable parts; and the entire dissolvable fiber in the printed parts was dissolved and removed. The parts not printed with the dissolving paste were non-dissolvable parts having stretchability of the base knit. Furthermore, the dissolving paste was printed with small floral patterns on the other predetermined parts, which were desired to have an intermediate stretchability and had 50% area ratio to the total area of the base knit, to form the other dissolvable part.

### Dissolving Agent Including Dissolving Accelerator

Glycerine/ethylene oxide 10 mol adduct: 10 parts by mass (hereinafter, referred to as “parts”)
Quaternary ammonium salt as shown in the following formula: 2.5 parts FINEGUM G 17 (manufactured by Dai-ichi Kogyo Seiyaku Co., Ltd.): 6 parts Water: 81.5 parts

{[C₁₂H₂₅N(CH₂C₆H₅)(CH₂CH₂O)ₘH](CH₂CH₂O)ₙH}+Cl⁻

(Mixture of (m+n)=2 to 8)

Next, this knit including parts dissolved and removed was dyed to be multicolor with the following dyeing condition to prepare a high-design Raschel knit having partially different stretchability. The surface of knit, which was not dissolved and removed, was colored reddish blue by a blue cationic dye and a red acid dye; and the surface of the knit, which was dissolved and removed, including floral patterns, was colored red because 6/6 nylon fiber was dyed red by the red acid dye and polyurethane fiber was not dyed. In addition, the interfaces of patterns between the parts having no dissolved and removed portion and the parts having dissolved and removed portions became satisfactory transparent and sheer parts.

### Dyeing Condition

Cathilon blue CD-FBLH (cationic dye manufactured by Hodogaya Chemical Co., Ltd.): 1% owf (to fiber mass)

Kayanol red NB (acid dye manufactured by Nippon Kayaku Co., Ltd.): 0.5% owf

Cathilon salt W new conc (suspension agent manufactured by Hodogaya Chemical Co., Ltd.): 1% owf

Liquor ratio: 1:50

Temperature and time: 100° C., 40 minutes

The stretchability of the obtained Raschel knit was evaluated using extension percentage and stress when extended to 30%. At the part having no dissolved and removed portion, the extension percentage was 150% in the warp direction and 60% in the weft direction, and the stress when extended to 30% was 170 cN/gf in the warp direction and 290 cN/gf in the weft direction. In the part having dissolved and removed portions, the extension percentage was 180% in the warp direction and 160% in the weft direction, and the stress when extended to 30% was 80 cN/gf in the warp direction and 50 cN/gf in the weft direction. The ratio of the extension percentage at the part having dissolved and removed portions to the extension percentage at the part having no dissolved and removed portion was 1.2 times in the warp direction and 2.7 times in the weft direction, and the stress ratio when extended to 30% was 0.47 times in the warp direction and 0.17 times in the weft direction. The part having dissolved and removed portions had higher stretchability than the part having no dissolved and removed portion. In the part having no dissolved and removed portion including the part having dissolved and removed portions of floral patterns with 40% area ratio, the extension percentage was 160% in the warp direction and 100% in the weft direction, and the stress when extended to 30% was 120 cN/gf in the warp direction and 100 cN/gf in the weft direction, so this part had an intermediate stretchability. The cloth strength of the obtained Raschel knit was 360 kPa at the part having no dissolved and removed portion and 200 kPa at the part having dissolved and removed portions.

The Raschel knit was cut to prepare a girdle. The girdle was a product including stretching parts having different cloth-stretchability provided at predetermined parts to impart desirable partially different compression. When a person put this product on, the person did not feel difference in level of the knit, did not feel thickness, and did not feel sweaty due to the product being thin; and felt extremely soft. If the size and design of this product are changed, they have been changed by knitting the product by changing the knitting structure, however, in this method, they can be changed with the same knit having stretchability before and after conducting some processes and in steps after dissolving and removing, so this method can be flexibly used.

### Example 2

The same procedure as in Example 1 was carried out except that the course was 45/inch and the well was 50/inch, and the dissolving paste was printed with small floral patterns on the other predetermined parts, which were desired to have an intermediate stretchability and had 50% area ratio to the total area of the base knit, to form the other dissolvable part.

The cloth-stretchability of the obtained Raschel knit was evaluated using extension percentage and stress when extended to 30%. At the part having no dissolved and removed portion, the extension percentage was 148% in the warp direction and 74% in the weft direction, and the stress when extended to 30% was 168 cN/gf in the warp direction and 347 cN/gf in the weft direction. In the part having dissolved and removed portions, the extension percentage was 119% in the warp direction and 245% in the weft direction, and the stress when extended to 30% was 80 cN/gf in the warp direction and 51 cN/gf in the weft direction. The ratio of the extension percentage at the part having dissolved and removed portions to the extension percentage at the part having no dissolved and removed portion was 0.8 times in the warp direction and 3.3 times in the weft direction, and the stress ratio when extended to 30% was 0.48 times in the warp direction and 0.15 times in the weft direction. The part having dissolved and removed portions had higher stretchability than the part having no dissolved and removed portion. In the part having no dissolved and removed portion including the part having dissolved and removed portions of floral patterns with 50% area ratio, the extension percentage was 140% in the warp direction and 133% in the weft direction, and the stress when extended to 30% was 147 cN/gf in the warp direction and 147 cN/gf in the weft direction, so this part had an intermediate stretchability. The cloth strength of the obtained Raschel knit was 350 kPa at the part having no dissolved and removed portion and 200 kPa at the part having dissolved and removed portions.

### Comparative Example 1

A Raschel knit was obtained by carrying out the same procedure as in Example 1 except that 6/6 nylon fiber of the non-dissolvable fiber C having non-stretchability in Example 2 was replaced by the untwisted yarn of 33 dtex/36 f of modified polyethylene terephthalate fiber Composed of the same polymer as the dissolvable fiber A of Example 1. The Raschel knit was scoured with open width and set to prepare a base knit of a cloth having a course of 45/inch, a well of 50/inch, and an opening of 250 g/m². The used modified polyethylene terephthalate had fiber-stretch and extension percentage of 33.8%, and the mixing ratio (weight) of these fibers in the base knit was the modified polyethylene terephthalate fiber 85% and polyurethane fiber 15%.

The base knit was dissolved and removed by the same procedure as Example 2. The stretchability of the obtained Raschel knit was evaluated using extension percentage and stress when extended to 30%. At the part having no dissolved and removed portion, the extension percentage was 160% in the warp direction and 60% in the weft direction, and the stress when extended to 30% was 140 cN/gf in the warp direction and 250 cN/gf in the weft direction. In the part having dissolved and removed portions, the extension percentage was 210% in the warp direction and 350% in the weft direction, and the stress when extended to 30% was 40 cN/gf in the warp direction and 20 cN/gf in the weft direction. The ratio of the extension percentage at the part having dissolved and removed portions to the extension percentage at the part having no dissolved and removed portion was 1.3 times in the warp direction and 5.5 times in the weft direction, and the stress ratio when extended to 30% was 0.29 times in the warp direction and 0.08 times in the weft direction. The part having dissolved and removed portions had higher stretchability than the part having no dissolved and removed portion. The cloth strength of the obtained Raschel knit was 280 kPa at the part having no dissolved and removed portion, and that at the part having dissolved and removed portions was not able to be measured.

The Raschel knit was cut to prepare the same girdle as that of Example 1. The girdle had different compression at the predetermined parts; however, the dissolved and removed part composed of only polyurethane fiber imparted excessive high cloth-stretchability to the girdle and the stress when extended to 30% was low. Therefore, this girdle was not a desirable product having partially different compression.

### Example 3

A composition yarn was prepared to have a “TRISKIN” structure by using an untwisted yarn of 56 dtex/24 f core-sheath composite fiber as a dissolvable fiber A without using the non-dissolvable fiber C by the same procedure as Example 1. The untwisted yarn was obtained by core-sheath-conjugate-spinning a core component and a sheath component with the ratio of 1:2 at 290° C. and extending, in which the sheath component was modified polyethylene terephthalate prepared by copolymerizing polyethylene terephthalate with 2% by mol 5-sodium sulfo isophthalic acid having an inherent viscosity of 0.6 (measured a polymer dissolved in a mixed solvent of phenol:tetrachloroethane being 1:1 using a Ubbelohde viscometer at 25° C.) and a melting point of 244° C. and 5% by mol adipic acid; and the core component was polyethylene terephthalate having an inherent viscosity of 0.72 and a melting point of 256° C. The composition yarn was knitted to prepare a Raschel knit. The Raschel knit was scored with an open width and set to prepare a base knit having a course of 48/inch, a well of 50/inch, and an opening of 240 g/m² by the same procedure as Example 1. The used core-sheath composite fiber had fiber-stretch and extension percentage of 32%, and the mixing ratio (weight) of these fibers in the base knit was the core-sheath composite fiber 85% and polyurethane fiber 15%.

The base knit was dissolved and removed by the same procedure as Example 1 and further a part of portions not dissolved and removed was resin-finished with small dots patterns using a printing method at a normal condition. In the dissolved and removed portions of the obtained knit, polyethylene terephthalate of the core portion of the dissolvable fiber A remained as a fine fiber having about 20 dtex/24 f (which corresponded to the non-dissolvable fiber C) in addition to polyurethane fiber. This fine fiber inconspicuously contributed to retention of strength and control of cloth-stretchability in the dissolved and removed portions.

The cloth-stretchability of the obtained Raschel knit was evaluated using extension percentage and stress when extended to 30%. At the part having dissolved and removed portions, the extension percentage was 160% in the warp direction and 170% in the weft direction, and the stress when extended to 30% was 100 cN/gf in the warp direction and 70 cN/gf in the weft direction. In the part having no dissolved and removed portion, the extension percentage was 130% in the warp direction and 50% in the weft direction, and the stress when extended to 30% was 190 cN/gf in the warp direction and 300 cN/gf in the weft direction. The ratio of the extension percentage at the part having dissolved and removed portions to the extension percentage at the part having no dissolved and removed portion was 1.2 times in the warp direction and 3.4 times in the weft direction, and the stress ratio when extended to 30% was 0.53 times in the warp direction and 0.23 times in the weft direction. The part having dissolved and removed portions had higher stretchability than the part having no dissolved and removed portion.

In the resin-finished part of the part having no dissolved and removed portion, the extension percentage was 80% in the warp direction and 30% in the weft direction, and the stress when extended to 30% was 220 cN/gf in the warp direction and 360 cN/gf in the weft direction. The resin-finished part had lower cloth-stretchability than other parts having no dissolved and removed portion which were not rein-finished, and therefore, the obtained Raschel knit had multistage different cloth-stretchabilities. The cloth strength of the obtained Raschel knit was 300 kPa at the part having no dissolved and removed portion and 190 kPa at the part having dissolved and removed portions.

The Raschel knit was cut to prepare a girdle. The girdle was a product including stretching parts having different cloth-stretchability provided at predetermined parts to impart desirable partially different compression. When a person put this product on, the person did not feel a difference in the level of the knit, did not feel a difference in the thickness, and did not feel sweaty due to the product being thin; and felt that the material was extremely soft. If the size and design of this product are changed, they have been changed by knitting the product by changing the knitting structure, however, in this method, they can be changed with the same knit having stretchability before and after conducting some processes and in steps after dissolving and removing, so this method can be flexibly used.

### INDUSTRIAL APPLICABILITY

The present invention provides cloths having partially different stretchability with various shapes only by changing a mold to be used for printing when a dissolving agent is printed in a process of dissolution and removal. Thereby, cloths having different woven and knitted structures do not need manufacturing in accordance with a model number and size, lead time for manufacturing can be shortened, and various cloths or cloths having small lot sizes can be manufactured.

1. A cloth having partially different cloth-stretchability, comprising:
a portion having relatively high cloth-stretchability and a portion having relatively low cloth-stretchability,
wherein the portion having relatively high cloth-stretchability is composed of a fiber having fiber-stretchability and a fiber having non-fiber-stretchability and has higher extension percentage than that of the portion having relatively low cloth-stretchability.

2. The cloth according to claim 1, wherein an extension percentage of the portion having relatively high cloth-stretchability to an extension percentage of the portion having relatively low cloth-stretchability is 1.1 to 5.0 times, and a stress when extended to 30% of the portion having relatively high cloth-stretchability to a stress when extended to 30% of the portion having relatively low cloth-stretchability is 0.05 to 0.90 times.

3. The cloth according to claim 1, wherein the portion having relatively high cloth-stretchability is dissolved and removed.

4. Clothes comprising a cloth according to any one of claims 1 to 3.

5. Cloths selected from the group consisting of: a girdle, a body suit, a leotard, panties, brassieres, leggings, a towel for sports, underwear for sports, socks, and swimming wear.

6. A method of manufacturing a cloth having partially different cloth-stretchability, comprising: printing a part to be dissolved and removed of a cloth-stretchable base cloth with a dissolving paste including a dissolving accelerator to make a printed part; removing a part of or all of dissolvable fiber A of the printed part; and fulfilling the following conditions (1) to (4):
(1) the cloth-stretchable base cloth comprises the dissolvable fiber A, a non-dissolvable fiber B, and a non-dissolvable fiber C,
(2) at least a part of the dissolvable fiber A is composed of a polymer to be dissolved by the dissolving agent,
(3) the non-dissolvable fiber B is undissolved in the dissolving agent and has fiber-stretchability,
(4) the non-dissolvable fiber C is undissolved in the dissolving agent and has non-fiber-stretchability.

7. The method of manufacturing a cloth having partially different cloth-stretchability according to claim 6, wherein the extension percentage of the part having dissolved and removed portions to the part having no dissolved and removed portion is 1.1 to 5.5, and the stress ratio when extended to 30% of the part having dissolved and removed portions to the part having no dissolved and removed portion is 0.05 to 0.9 in the warp or weft direction or both warp and weft directions.

8. The method of manufacturing a cloth having partially different cloth-stretchability according to claim 6, wherein the dissolvable fiber A is modified polyester fiber Composed of polyester polymer modified by a compound including an alkali metal sulfonic acid group.

9. The method of manufacturing a cloth having partially different cloth-stretchability according to claim 6, wherein the non-dissolvable fiber B is polyurethane fiber.

10. The method of manufacturing a cloth having partially different cloth-stretchability according to claim 6, the non-dissolvable fiber C is polyamide fiber.

11. The method of manufacturing a cloth having partially different cloth-stretchability according to claim 6, further comprising conducting resin finishing to a part of the part having no dissolved and removed portion of the cloth.

12. The method of manufacturing a cloth having partially different cloth-stretchability, comprising: printing a part to be dissolved and removed of a cloth-stretchable base cloth with a dissolving paste including a dissolving accelerator to make a printed part; removing a part of dissolvable fiber A of the printed part; and fulfilling the following conditions (5) to (7):
(5) the cloth-stretchable base cloth comprises the dissolvable fiber A and a non-dissolvable fiber B,
(6) the dissolvable fiber A is composed of a polyester polymer modified by a compound including an alkali metal sulfonic acid group and a non-dissolvable polymer which is undissolved in the dissolving agent,
(7) the non-dissolvable fiber B is undissolved in the dissolving agent and has fiber-stretchability.

13. The method of manufacturing a cloth having partially different cloth-stretchability according to claim 12, wherein the extension percentage of the part having dissolved and removed portions to the part having no dissolved and removed portion is 1.1 to 5.5, and the stress ratio when extended to 30% of the part having dissolved and removed portions to the part having no dissolved and removed portion is 0.05 to 0.9 in the warp or weft direction or in both the warp and weft directions.

14. The method of manufacturing a cloth having partially different cloth-stretchability according to claim 12, wherein the non-dissolvable fiber B is polyurethane fiber.

15. The method of manufacturing a cloth having partially different cloth-stretchability according to claim 12, further comprising conducting resin finishing to a part of the part having no dissolved and removed portion of the cloth.
